(19) United States
(12) Patent Application Publication
(10) Pub. No.: US 2010/0023254 A1
(43) Pub. Date: Jan. 28, 2010

(54) NAVIGATION SYSTEM

(76) Inventor: Hiroshi Machino, Tokyo (JP)

Correspondence Address: BIRCH STEWART KOLASCH & BIRCH, PO BOX 747, FALLS CHURCH, VA, 22040-0747, US

(21) Appl. No.: 12/442,035

(22) PCT Filed: Aug. 14, 2007
(86) PCT No.: PCT/JP2007/065863

§ 371 Date: Mar. 19, 2009

(30) Foreign Application Priority Data
Nov. 10, 2006 (JP) 2006-305589

(51) Int. Cl. G01C 21/36

(52) U.S. Cl. 701/201

(57) ABSTRACT

A navigation system includes map data storing means storing map data; current position calculating means calculating a current position of a vehicle; and a guiding section detecting a moving direction of the vehicle based on the map data acquired from the map data storing means and the current position of the vehicle calculated by the current position calculating means, and guiding the vehicle by outputting guidance information including road information, destination directional information, and famous facility or scenic spot directional information about an intersection when the vehicle approaches a fore intersection in the detected moving direction.

### TECHNICAL FIELD

The present invention relates to a navigation system providing route guidance from a current position of a vehicle to the destination, and more particularly to a technology of guiding a user to the destination or transit points even if the destination or the transit points are not set.

### BACKGROUND ART

The conventional on-vehicle navigation system, when a user sets the destination or transit points the user wishes by inputting an address, a facility name, and a peripheral facility, etc., begins to a route search, provides route guidance by display or voice based on the searched route, and thereby guides the user to the destination or the transit points.

As a method of inputting the destination or the transit points to the navigation system, a variety of methods are known, such as an address search, a facility category search, a postal code search, and an intersection search, etc. However, these methods require key operations such as complicated key operations, an input confirmation, an execution of route search processing, a display of a map screen including the destination or the transit points, a confirmation operation of the destination or the transit points, and a guidance starting operation.

Such operation of inputting the destination or the transit points is no other than a complicated and burdensome operation to a user. For example, in case the user does not know an address of the destination or the transit points, or in case facility categories are too many to identify by the user to which category the destination or the transit points belong, the user must do over again many times an input operation, which results in taking much time to complete the setting of the destination or the transit points.

In this connection, Patent Document 1 discloses, as a related art, a vehicle guiding method of a navigation system which is arranged so as to be able to guide a vehicle along a route without inputting the destination. The vehicle guiding method involves previously including in a map database image data of road signs, correspondency between the intersection constituting link and a destination direction, and the absolute longitude and latitude of an entry point in all directions, and displaying a road sign on a display screen when the vehicle approaches a certain intersection where a road sign being disposed. When the vehicle passes through the intersection, discrimination is done to identify the destination direction of the vehicle from the correspondency data between the intersection constituting link and the destination direction. When the vehicle runs the intersection in the same direction as the destination direction running till then, the navigation system takes an entry point to the direction as the destination, or when the vehicle runs the intersection in a new different direction, the navigation system takes an entry point to the new direction as the destination, and a guidance route to the destination is found to display the route on a map.

Patent Document 1: JP-A1998-281787

As described above, the conventional navigation system is defective in that such operation of inputting the destination or the transit points is no other than a complicated and burdensome operation to a user. In case the user does not know an address of the destination or the transit points, or in case facility categories are too many to identify by the user to which category the destination or the transit points belong, the user must do over again many times an input operation, which results in taking much time to complete the setting of the destination or the transit points.

The present invention has been made to solve the above-mentioned problems, and an object of the present invention is to provide a navigation system which is capable of guiding a user to the destination or the transit points the user intends even if the destination or the transit points are not set.

### DISCLOSURE OF THE INVENTION

In order to solve the above-mentioned problems, the navigation system according to the present invention includes map data storing means storing map data; current position calculating means calculating a current position of a vehicle; and a guiding section, when the vehicle approaches a fore intersection in the detected moving direction, guiding a user by detecting a moving direction of the vehicle based on the map data acquired by the map data storing means and the current position of the vehicle calculated by the current position calculating means, and by outputting guidance information including road information, destination directional information, and famous facility or scenic spot directional information.

According to the navigation system of the present invention, the navigation system is arranged to guide a user by outputting the guidance information including the road information, the destination directional information, and famous facility or scenic spot directional information when the vehicle approaches the fore intersection in the moving direction. Thus, the navigation system liberates the user from complicated input operations of the destination, and enables the user to provide route guidance to the destination or the transit points the user intends even if the user does not know an address or cannot identify a facility category.

### BRIEF DESCRIPTION OF THE DRAWINGS

FIG. 1 is a block diagram showing a configuration of a navigation system according to the first embodiment of the present invention.

FIG. 2 is a flowchart showing an operation of the navigation system according to the first embodiment of the present invention.

FIG. 3 is a diagram showing an example of a current position screen displayed in an navigation system according to the first embodiment of the present invention.

FIG. 4 is a diagram showing an example of an intersection information map displayed, when a vehicle approaches an intersection, on the navigation system according to the first embodiment of the present invention.

FIG. 5 is a diagram showing an example of an intersection information map displayed on the navigation system according to the first embodiment of the present invention.

FIG. 6 is a diagram showing in detail the intersection information map shown in FIG. 5.

FIG. 7 is a diagram showing in more detail the intersection information map shown in FIG. 6.

FIG. 8 is a diagram showing in more detail the intersection information map shown in FIG. 7.

FIG. 9 is a diagram showing another example of an intersection information map displayed on the navigation system according to the first embodiment of the present invention.

### BEST MODE FOR CARRYING OUT THE INVENTION

Hereinafter, embodiments of the present invention will now be described with reference to the accompanying drawings in order to explain the present invention in further detail.

### First Embodiment

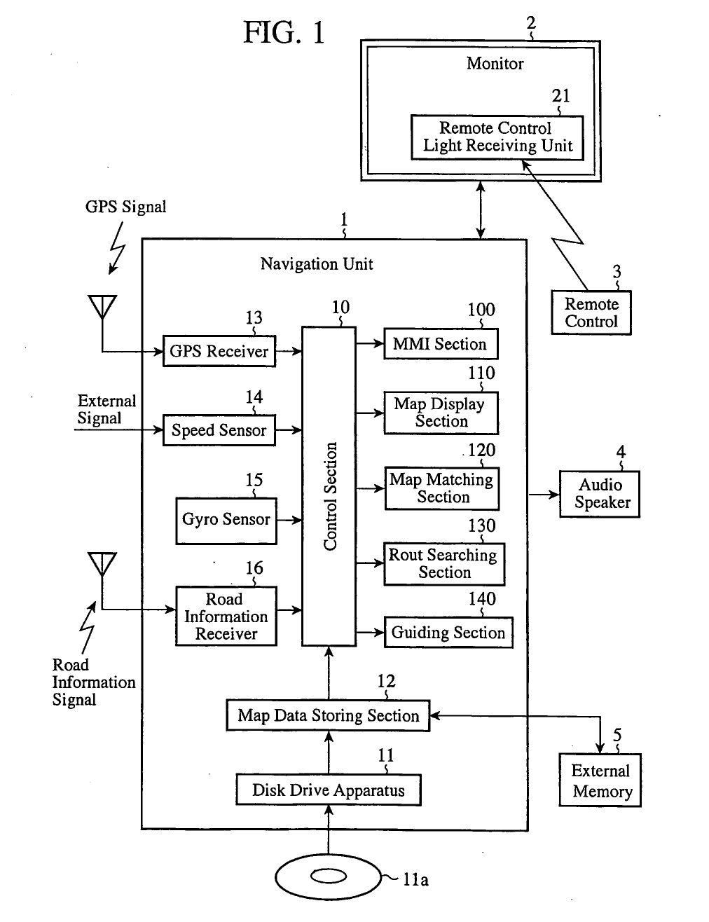

FIG. 1 is a block diagram showing a configuration of a navigation system according to the first embodiment of the present invention. The navigation system includes a navigation unit 1, a monitor 2 for displaying a map, a remote controller (hereinafter referred to as a “remocon”) 3, an audio speaker 4, and an external memory 5.

The navigation unit 1 is the nucleus of the navigation system, and executes processing such as a map display, a route search, and guidance. In the guidance processing, the navigation system gives guidance etc, by voice concurrently with when a vehicle approaches a fore intersection in the moving direction, the navigation system displays road information, destination directional information, and famous facility or scenic spot directional information about the intersection. The detail of the navigation unit 1 will be mentioned later.

The monitor 2 is composed e.g. of an LCD (Liquid Crystal Display), and displays a map, a current position mark of a vehicle, the road information, the destination directional information, and the famous facility or scenic spot directional information about the fore intersection in the moving direction, and other various messages, in response to a display signal sent from the navigation unit 1. The monitor 2 is provided with a remocon light-receiving section 21. The remocon light-receiving section 21 receives an optical signal sent from the remocon 3, and sends it to the navigation unit 1 through the monitor 2.

The remocon 3 is used for scrolling a map by a user, or for responding to a message prompting the user to do an operation, which is outputted from the monitor 2 or the audio speaker 4. Instead, in place of the remocon 3 or in combination with the remocon 3, a touch panel may be provided in which a variety of information is inputted by directly touching to a touch sensor mounted on a screen of the monitor 2.

The audio speaker 4 outputs a guidance message by voice in response to an audio signal sent from the navigation unit 1. The external memory 5 is optional, and is made e.g. of an HDD (Hard Disk Drive). The external memory 5 stores map data similar to that stored in a record medium 11a to be inserted in a disk drive device 11 described later.

The navigation unit 1 will now be detailed below. The navigation unit 1 is composed of a control section 10; the disk drive device 11; a map data storing section 12; a GPS (Global Positioning System) receiver 13; a speed sensor 14; a gyro sensor 15; a road information receiver 16; a man-machine interface section (hereinafter referred to as an “MMI”) 100; a map display section 110; a map matching section 120; a route search section 130; and a guiding section 140. In parenthesis, the route search section 130 is not a constituent component indispensable for implementing the present invention, and may do away with from the navigation unit 1.

The control section 10 is made e.g. of a microcomputer, and is responsible for entire control of the navigation unit 1. The MMI section 100, map display section 110, map matching section 120, route searching section 130, and guiding section 140 are each constituted by an application program executed under the control of the microcomputer.

The disk drive device 11 cannot reproduce the recorded contents until a record medium 11a such as a DVD (Digital Versatile Disc) or a CD (Compact Disc), in which the map data and the map database including intersection information are stored, is inserted into the disk drive device. The map data is defined by nodes, and road links, etc, and the road information and the destination directional information included in the intersection information include address data (City, Chome, Street number, and House number), road data of the fore intersection in the moving direction and intersections beyond the fore intersection, name data of the destination direction, road sign image data, an intersection constituting link, famous facility data including famous facility directional information, scenic spot data including scenic spot directional information, road number data, and link information such as a place name, a bridge name, a tunnel name, and the absolute latitude and longitude of each spot, etc. The map data and intersection information reproduced by the disk drive device 11 are sent to the map data storing section 12.

The map data storing section 12 temporarily stores the map data sent from the disk drive device 11 or from the external memory 5. The map data storing means of the present invention is composed of the disk drive device 11 or the external memory 5 and the map data storing section 12. The map data and intersection information stored in the map data storing section 12 are used respectively for display of a map and intersection guide information touched upon later.

The GPS receiver 13 detects a current position of a vehicle based on GPS signals received from a GPS satellite through its antenna. The current position data indicating the current position of the vehicle, which is detected by the GPS receiver 13, is sent to the control section 10. The speed sensor 14 detects a moving speed of the vehicle based on an external signal sent from the vehicle on which the navigation system is mounted. The speed data representing the moving speed of the vehicle detected by the speed sensor 14 is sent to the control section 10.

The gyro sensor 15 detects a moving direction of the vehicle. Orientation data indicating the moving direction of the vehicle detected by the gyro sensor 15 is sent to the control section 10. The control section 10 detects the current position of the vehicle by an autonomous navigation technique based on the speed data from the speed sensor 14 and the orientation data from the gyro sensor 15. Even though the GPS receiver 13 gets into the situation where the receiver cannot detect the current position of the vehicle when the vehicle enters e.g. into a tunnel, etc, the autonomous navigation technique allows detecting the current position of the vehicle. By virtue of this, the navigation system can always correctly detect the current position of the vehicle. The current position calculating means of the present invention is composed of the GPS receiver 13, the speed sensor 14, the gyro sensor 15, and the control section 10 processing the data sent from these devices.

A road information receiver 16 receives a road information signal sent e.g. from the road traffic data communication system. The road information signal received by the road information receiver 16 is sent to the control section 10. The control section 10 creates a message representing traffic snarl information of the road based on the road information signal, and informs a user through the monitor 2 and the audio speaker 4.

The MMI section 100 processes a command created by manipulating an operation panel (not shown) or a command sent from the remocon 3 through the monitor 2. The MMI section 100 provides communication between the navigation system and the user. The map display section 110 generates drawing data for causing the monitor 2 to display thereon a map, and the intersection information map, etc. The map and intersection information map are displayed on the screen of the monitor 2 by sending the drawing data generated by the map display section 110 to the monitor 2.

The map matching section 120 brings a vehicle location, which is created based on the current position data sent from the GPS receiver 13 or the current position data generated using the speed data sent from the speed sensor 14 and the orientation data sent from the gyro sensor 15, into correspondence with the map represented by the map data read out from the map data storing section 12, and displays a vehicle location mark on the map.

The route search section 130 searches for routes from the current position of the vehicle to the destination. The guiding section 140 creates, as the vehicle travels, the guide information map and a voice guidance message representing the road information, the destination directional information, and the famous facility or scenic spot directional information, etc about the fore intersection in the moving direction. The guide information map is displayed on the monitor 2, and the voice guidance message is outputted from the audio speaker 4.

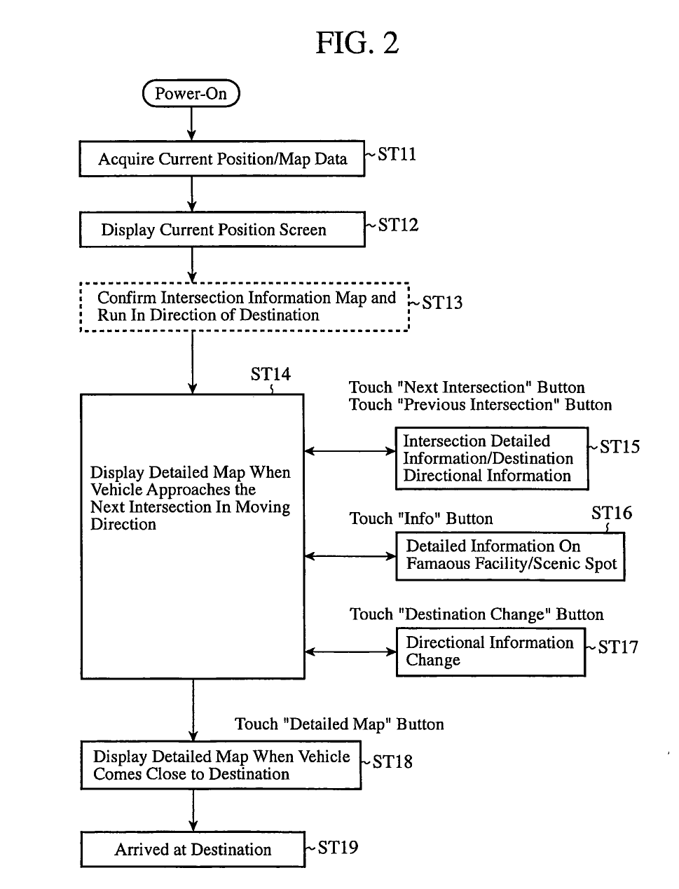

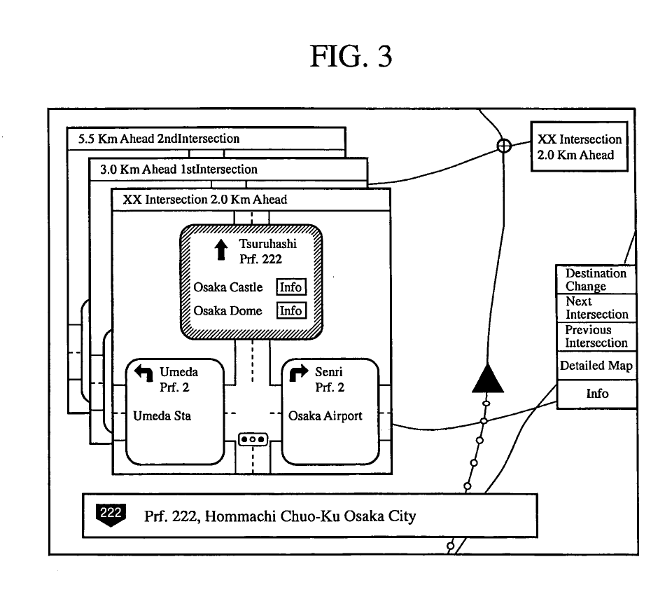

Then, the operation of the navigation system thus arranged as above will be described, with a focus placed on the route guide processing, referring to the flow chart shown in FIG. 2 and exemplary screens shown in FIGS. 3-9.

When the navigation system is powered, the current position data and the map data are acquired first (step ST11). In other words, the control section 10 sends the current position data acquired from the GPS receiver 13 or the current position data detected by the autonomous navigation technique to the map matching section 120. Further, the disk drive device 11 reads out the map data from the record medium 11a set and stores it to the map data storing section 12. The map matching section 120 reads out the map data from the map data storing section 12, and carries out matching processing for superposing the vehicle position mark on a position corresponding to the current position data received from the control section 10. The map data having subjected to the matching processing is then sent to the map display section 110. The map display section 110 generates drawing data based on the map data sent from the map matching section 120, and sends it to the monitor 2.

After that, a current position screen is displayed (step ST12). That is, the monitor 2 generates drawing data based on the road information, the destination directional information, and the famous facility or scenic spot directional information about the fore intersection in the moving direction, included in the intersection information read out from the map data storing section 12, and sends it to the monitor 2 concomitantly with the monitor 2 displays a map, with the current position of the vehicle taken as the center, based on the drawing data received from the map display section 110. Thereby, the current position screen including the map, with the current position of the vehicle taken as the center and the intersection information map as shown e.g. in FIG. 3 is displayed on the monitor 2.

The current position screen shown in FIG. 3 displays a map including the vehicle position mark, a message indicating the current position of the vehicle “Prefectural road 222, Hommachi, Chuome, Osaka City,” three intersection information maps (XX intersection 2.0 km ahead, the 1st intersection 3.0 km ahead, and the 2nd intersection 5.5 km ahead), and a message indicating the intersection information map “XX intersection 2.0 km ahead.” Further, the current position screen displays a “Destination Change” button, a “Next Intersection” button, a “Previous Intersection” button, a “Detailed Map” button, and an “Info” button. The user can execute a function assigned to the button by selecting one of the buttons using the remocon 3. The same holds true for screens described later.

The user confirms the intersection information map displayed on the monitor 2, and runs in the direction of the desired destination (step ST13).

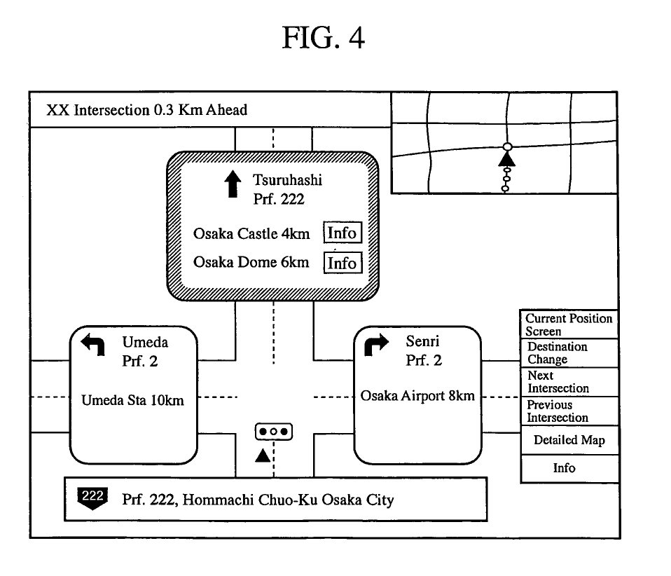

Subsequently, when the vehicle approaches the next fore intersection in the moving direction, a detailed map is displayed (step ST14). More precisely, the current position screen, which has been displayed till then on the monitor 2 as shown in FIG. 3, is automatically changed to a screen as shown in FIG. 4, on which the map is displayed on a reduced scale and the intersection information map is displayed on a magnified scale. The moving direction is detected based on the data indicating the current position of the vehicle detected in the control section 10 by the autonomous navigation technique, on the basis of the map data acquired by the map data storing section 12, the data indicating the current position of the vehicle detected by the GPS receiver 13, or the speed data from the speed sensor 1 and the orientation data from the gyro sensor 15.

Remark parenthetically, it may also be arranged that the moving direction is detected, after the vehicle passed through an intersection, based on the data indicating the current position of the vehicle detected by the control section 10 by the autonomous navigation technique on the basis of the intersection constituting link of the intersection read out from the map data storing section 12 and the data indicating the current position of the vehicle detected by the GPS receiver 13, or on the basis of the data indicating the current position of the vehicle detected in the control section 10 by the autonomous navigation technique based on the speed data from the speed sensor 14 and the orientation data from the gyro sensor 15. Say in addition, while the reduced map and the magnified intersection guide map are displayed on an exemplary screen shown in FIG. 4, it may also be possible to arrange to display magnified only the intersection information map.

When in the information map screen at the time of approach to an intersection, shown in FIG. 4, the screen returns to a usual current position screen as shown in FIG. 3. It should be noted that when the vehicle passed through the intersection, the screen is automatically changed from the intersection information map at the time of approach to the intersection, as shown in FIG. 4, to the usual current position screen as shown in FIG. 3.

When in the current position screen shown in FIG. 3 or the intersection information map shown in FIG. 4, the “Next Intersection” button is selected using the remocon 3, the guiding section 140 displays the next intersection information map (step ST15). For example, when the “Next Intersection” button is selected under the condition where the intersection information map of “XX intersection 2.0 km ahead” is being displayed, the screen is changed to the intersection information map of “the 1st intersection 3.0 km ahead.” In a similar manner, when the “Previous Intersection” button is selected by the remocon 3, the previous intersection information map is displayed (step ST15). For example, when the “Previous Intersection” button is selected under the condition where the intersection information map of “the 1st intersection 3.0 km ahead” is being displayed, the screen is changed to the intersection information map of “XX intersection 2.0 km ahead.” A user can obtain the road information, the destination directional information, and the famous facility or scenic spot directional information, etc about any intersection by operating the “Next Intersection” button or the “Previous Intersection” button.

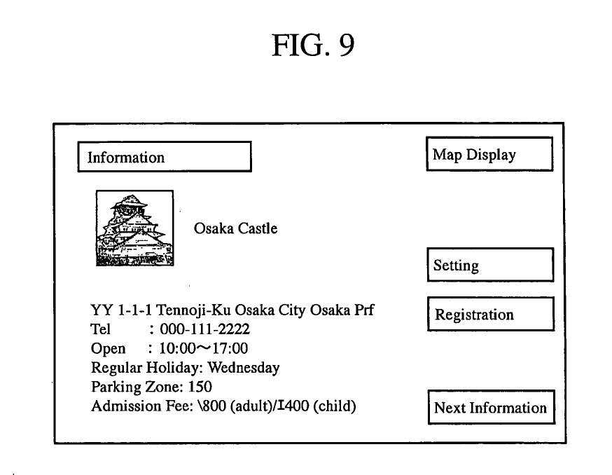

When in the current position screen shown in FIG. 3 or the intersection information map shown in FIG. 4, the “Info” button is selected by the remocon 3, the guiding section 140 displays, e.g. on a detailed information screen as shown in FIG. 9, detailed information of what is placed on famous facilities or scenic spots i.e. an “Info” mark shown at that time in the intersection information map (Osaka Castle and Osaka Dome in an example shown in FIG. 9) (step ST16). The “Info” button corresponds to the information output instructing means of the present invention. In passing, the detailed information includes, e.g., addresses, telephone numbers, opening date and hours, the presence of parking zones, and admission fees etc.

A “Map Display” button, a “Setting” button, a “Registration” button, and a “Next Information” button are displayed on the detailed information screen shown in FIG. 9. The “Map Display” button is used for returning to the current position screen or the intersection information map. The “Setting” button is used for setting a spot of which detailed information is displayed as the destination or transit points. The “Registration” button is used for registering a spot of which detailed information is displayed, in the navigation system. The “Next Information” button is used for displaying the next detailed information, e.g., to display the detailed information of Osaka Dome from the state where the detailed information of Osaka Castle is displayed.

When in the current position screen as shown in FIG. 3 or in the intersection information map as shown in FIG. 4, the “Destination Change” button is selected using the remocon 3, the guiding section 140 changes to a screen displaying a direction different from the moving direction e.g. to a screen displaying the direction where the vehicle turns to the right or turns to the left from the fore intersection in the moving direction (step ST17). The “Destination Change” button corresponds to the destination change instructing means of the present invention. This enables a user to have display thereon the road information, the destination directional information, and the famous facility or scenic spot directional information, eta about the intersection in a direction other than the moving direction.

Hereupon, the guiding section 140 can be arranged to suppose that intersections further beyond the fore intersection in the moving direction exits on an extension line of the road where the vehicle is running, that when the road is bifurcated, the intersection exists on a road branching to the side of the road having a higher road type classification condition (function class), or that when the road type classification condition etc. is the same, the intersection exists on the road branched to the side of a vehicle passing traffic lane (e.g., the left side when the vehicle is passing on the left side).

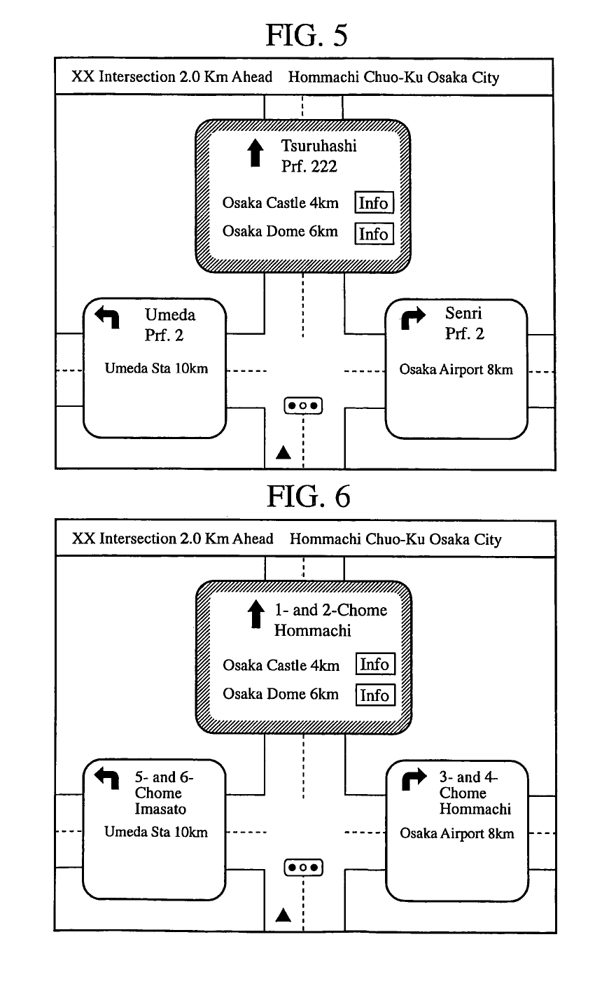

When in the current position screen as shown in FIG. 3 or in the intersection information map as shown in FIG. 4, the “Detailed Map” button is selected using the remocon 3, the guiding section 140 changes to the detailed map display (step ST18). The “Detailed Map” button corresponds to the detailed map display instructing means of the present invention. In the processing of the step ST18, e.g. if the screen is in the situation where the current position screen as shown in FIG. 5 is displayed, the guiding section 140 changes to the detailed information screen as shown in FIG. 6. To say more precisely, “Route 222, Tsuruhashi,” “Route 2, Umeda,” and “Route 2, Senri” that are “the destination directional information” are respectively changed to “1- and 2-Chome Hommachi,” “5- and 6-Chome Imasato,” and “3- and 4-Chome Hommachi,” that are specific addresses.

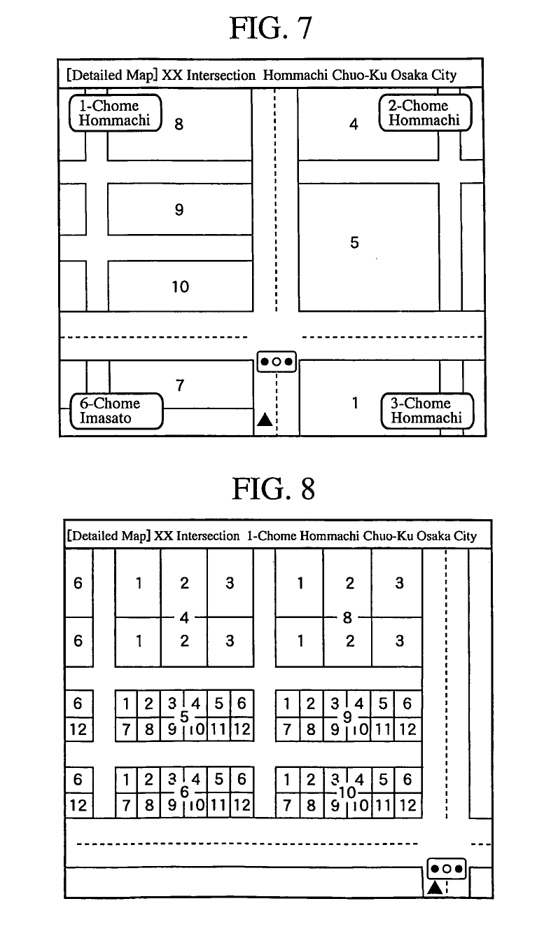

Further, when the screen is in the situation where detailed information as shown in FIG. 6 is displayed, the guiding section 140 changes to a screen where a detailed map as shown in FIG. 7 is displayed. Moreover, when the screen is in the situation where the detailed map as shown in FIG. 7 is displayed, the guiding section 140 changes to a screen where a further detailed map as shown in FIG. 8 is displayed. Thereby, the detailed map in the vicinity of the final destination the user desires can be displayed, and the user is guided to the destination (step ST19). It should be understood that the guiding section 140 may also be arranged to automatically display the detailed map in accordance with the road category type or the residential quarter information indicated by the map data acquired from the map data storing means 12.

As described above, with the navigation system according to the first embodiment of the present invention, the navigation system is arranged to output the guidance information including the road information, the destination directional information, and the famous facility or scenic spot directional information about the fore intersection, thereby guiding the user when the vehicle approaches the fore intersection in the moving direction. Thus, the navigation system liberates the user from a complicated destination input, and allows the user to guide to the destination or the transit points the user intends even when the user does not know an address or cannot identify the facility category.

### INDUSTRIAL APPLICABILITY

As described above, the navigation system according to the present invention is a navigation system capable of guiding a user to the destination or transit points the user intends by outputting for guidance the guidance information including the road information, the destination directional information, and the famous facility or scenic spot directional information about the fore intersection when the vehicle approaches the fore intersection in the moving direction even when the destination or transit points are not set. Thus, the navigation system is suitable for use e.g. in navigation systems mounted on vehicles.

1. A navigation system comprising:
Map data storing means for storing map data;
Current position calculating means for calculating a current position of a vehicle; and
a guiding section guiding the vehicle by detecting a moving direction of the vehicle based on map data acquired from the map data storing means and the current position of the vehicle calculated by the current position calculating means, and by outputting intersection information including road information, destination directional information, and famous facility or scenic spot directional information about an intersection when the vehicle approaches a fore intersection in the detected moving direction.

2. The navigation system as claimed in claim 1, wherein the guiding section guiding the vehicle by further outputting intersection information about intersections further beyond the fore intersection in the moving direction.

3. The navigation system as claimed in claim 1, wherein the guiding section guides the vehicle by detecting, after the vehicle passed through the intersection, the moving direction based on an intersection constituting link of the intersection and the current position of the vehicle calculated by the current position calculation means, and by outputting the intersection information including the road information, the destination directional information, and the famous facility or scenic spot directional information about the intersection when the vehicle approaches the fore intersection in the detected moving direction.

4. The navigation system as claimed in claim 1,
wherein the map data storing means stores the intersection information including address data; road data of the fore intersection and intersections beyond the fore intersection in the moving direction; destination directional name data; road sign image data; an intersection constituting link; famous facility data including famous facility directional information; scenic spot directional information; road number data; a place name; abridge name; a tunnel name; and the absolute latitude and longitude of each of those spots; and
wherein the guiding section guides the vehicle based on the intersection information stored in the map data storing means.

5. The navigation system as claimed in claim 1, wherein the guiding section supposes intersections further beyond the fore intersection in the moving direction, and outputs the intersection information including the road information, the destination directional information, and the famous facility or scenic spot directional information about the supposed intersection by consecutively changing these information.

6. The navigation system as claimed in claim 1,
wherein the navigation system further includes detailed map display instruction means for instructing the system to change to a detailed map; and
wherein the guiding section outputs detailed map information when an instruction to change to the detailed map is given by the detailed map display instructing means.

7. The navigation system as claimed in claim 6 wherein, the guiding section automatically outputs the detailed map information in accordance with a road category type or residential quarter information indicated by the map data acquired from the map data storing means.

8. The navigation system as claimed in claim 1,
wherein the navigation system further includes information output instructing means for instructing the system to output information; and
wherein the guiding section outputs detailed information about famous facilities or scenic spots when an instruction to output the information is given by the information output instructing means where the guiding section outputs the famous facility or scenic spot directional information.

9. The navigation system as claimed in claim 1,
wherein the navigation system further includes destination change instructing means for instructing the system to change the destination; and
wherein the guiding section outputs intersection information in a direction other than the moving direction when the guiding section is instructed to change the destination by the destination change instructing means.

10. The navigation system as claimed in claim 5, wherein the guiding section supposes that the intersections further beyond the fore intersection in the moving direction exits on an extension line of the road on which the vehicle is running, on a road branching to the side of the road having a higher road type classification condition when the road is bifurcated, or on a road branched to the side of a vehicle passing traffic lane if the road type classification condition is the same.
